(19) United States
(12) Patent Application Publication
(10) Pub. No.: US 2012/0110491 A1
(43) Pub. Date: May 3, 2012

(54) METHOD, SYSTEM AND COMPUTER PRODUCT FOR DISTRIBUTION OF DATA OBJECTS

(76) Inventor: Vincent Charles Cheung, Winnipeg (CA)

(21) Appl. No.: 13/266,575

(22) PCT Filed: Apr. 27, 2010
(86) PCT No.: PCT/CA10/00630

§ 371 Date: Jan. 17, 2012

(30) Foreign Application Priority Data
Apr. 27, 2009 (US) 61/173034

(51) Int. Cl. G06F 3/048

(52) U.S. Cl. 715/771

(57) ABSTRACT

A method, computer system and computer program for distributing data objects within a bounded region, whereby the data objects may be positioned as far apart from one another as possible. The output may be created entirely automatically, or may incorporate user input. The bounded region may be a variety of shapes and a plurality of data images may be distributed therein. The bounded region is defined as the area within a boundary wherein data object are allowed to be distributed. The distribution procedure may involve rotating and positioning the data objects within the bounded region. Distribution parameters relating to the data objects may be applied by the distribution procedure, for example, such as data object size, data object shape and any one or more regions of interest defined in a data object. An energy function may take into account the distribution parameters to produce a good output, such as a digital image collage. An optimization process may be applied to the energy function to produce a unique output.

### FIELD OF THE INVENTION

The present invention relates to digital image editing systems and methods. More particularly, the present invention relates to the automatic arrangement of object data, such as images in a collage.

### BACKGROUND OF THE INVENTION

A collage is an image formed by arranging a plurality of images on a canvas. Manual methods of generating image collages are known. In such methods, a digital image editing system is used to manually rotate, scale, crop, and place each photo in the canvas to form the collage. These manual methods require a significant amount of knowledge and skill by the user and are limited to collages with a small number of images as it is a time consuming process.

Other systems, such as U.S. patent application Ser. No. 11/403,625 “Image Collage Builder”, filed Apr. 13, 2006, attempt to accelerate this process by providing templates for the collages whereby the location, rotation, and scale of the images are fixed and collages can be created by inserting the desired images into the template. The variety of collages created in these systems is limited by the number of templates provided, as the generated collages are structurally identical to the template. Diakopoulos, Essa, “Mediating photo collage authoring”, in Proc. ACM Symposium on User interface Software and Technology (UIST), pp. 183-186, 2005, automates the placement of images in a template according to a desired effect, such as a particular ordering of the images, eg. sequentially in time, or adjacency constraints between images.

U.S. patent application Ser. No. 10/900,442 “Method and System for Automatic Generation of Image Distributions”, filed Jul. 28, 2004 and other methods automatically apply some perturbations to collage templates so as to create unique collages, but these methods still require a template with which to begin and so, the variety of collages created are limited and the number of images in the collages are restricted by the number of images in the initial templates. U.S. patent application Ser. No. 10/675,724 “Automatic Photo Album Page Layout”, filed Sep. 30, 2003, as well as Atkins, “Adaptive Photo Collection Page Layout”, In. Proc. Intern. Conf. on Image Processing (ICIP), pp. 2897-2900, 2004, and other early approaches to automatically arranging images in a collage without relying on a template restrict the collages to be a rectangular shape and the images be arranged in a grid with no options to rotate the images or allow for overlap of the images for either artistic purposes or for a more compact collage.

Fully automated approaches to creating collages do not rely on templates and instead, arrange the images in the canvas in such a way as to maximize the coverage of the canvas by the images and minimize the overlap of the images by other images. U.S. Pat. No. 7,620,267 “Collage Generation with Occlusion Costing”, issued Nov. 17, 2009; U.S. Pat. No. 7,576,755 “Picture Collage Systems and Methods”, issued Aug. 18, 2009; U.S. patent application Ser. No. 11/440,736, filed May 24, 2006; and Battiato et al., “Smart Photo Sticking”, Adaptive Multimedia Retrieval Retrieval, User, and Semantics, pp. 211-223, 2008 present algorithms to automatically arrange images in a collage by optimizing several different criteria, including minimizing the occluded salient areas of the images and minimizing the blank space in the collage. By the construction of the optimization criteria in these methods, they are finely tuned to a particular spacing between, and overlap of, the images in the collage. In the extreme case, with no overlap between images in the collage, these methods fail as there is nothing to optimize regarding the occlusion of the salient regions. These methods are also restricted to rectangular and simple shaped collages and cannot arrange images to form arbitrary shapes, such as non-contiguous shapes. Finally, these methods are computationally slow and can only handle a small number of images in a collage.

Related to the type of collages referenced here are various other modifications that also involve a plurality of images on a canvas. U.S. Pat. No. 6,075,905, issued Jun. 13, 2000, U.S. patent application Ser. No. 11/552,312 “Auto Collage”, filed Oct. 24, 2006, Rother, Bordeaux, Hamadi, Blake, “Autocollage”, in Proc. ACM SIGGRAPH, pp. 847-852, 2006, Agarwala et al., “Interactive Digital Photomontage”, in Proc. ACM SIGGRAPH, pp. 294-302, 2004, U.S. patent application Ser. No. 11/525,589 “Annealing Algorithm for Non-Rectangular Shaped Stained Glass Collages”, filed Sep. 22, 2006, and Chiu, Girgensohn, “Stained Glass Photo Collages”, in Proc. UIST, 2004, present methods for generating a variant of collages with no explicit overlap between the images. Instead of having the images overlap, the images are blurred at their boundaries to create a seamless construct, or in the case of the stained glass collages, a border is drawn along these image boundaries instead of blurring. These methods do not take into consideration the possibility of the images being rotated within the collage for artistic purposes, nor do they take into account the ordering of the layers as they explicitly disallow overlapping. Finally, inherent to these collages, a specific spacing between the images and density of the images in the collage is required.

Mosaics are another related image technique whereby non-overlapping small images or tiles are pieced together in such a way to resemble an image. This artistic technique has existed for centuries and various digital methods have been developed to simulate this technique including Dalal et al., “A Spectral Approach to NPR Packing”, in Proc. Symposium on Non-Photorealistic Animation and Rendering (NPAR), pp. 71-78, 2006, Smith et al, “Animosaics”, in. Proc. ACM SIGGRAPH, pp. 29-31, 2005, and Kim, Pellancini, “Jigsaw Image Mosaics”, in Proc. ACM SIGGRAPH, pp. 657-664, 2002. The mosaic idea has also been extended to images and videos that are not uniform in color or texture: Silvers, Hawley, “Photomosaics”, Henry Holt and Co., 1997, Finkelstein, Range, “Image Mosaics”, Lecture Notes in Computer Science, Vol: 1375, pp. 11-22, 1998, Orchard, Kaplan, “Cut-Out Image Mosaics”, in Proc. Symposium on NPAR, pp. 79-87, 2008, Klein et al., “Video Mosaics”, in Proc. Symposium on NPAR, pp. 21-28, 2002. In these image mosaics, the images on the canvas are placed in locations where the images match the underlying mosaic template image in color and texture. In some cases, to overcome mismatches between the images in the mosaic and the desired overall image, the color of the individual images may be altered.

Stippling is the technique of using small dots to simulate varying degrees of shading. An increased density of these dots creates a darker shade. Second, “Weighted Voronoi Stippling”, in. Proc. Symposium on NPAR, pp. 37-43, 2002, uses non-overlapping small icon tiles in replace of dots to form a mosaic-like result. The unique characteristic here is the varying degrees of density of the tiles in the mosaic.

### SUMMARY OF THE INVENTION

In one aspect the present invention is a method of producing a distribution of data objects related to a bounded region, comprising: selecting one or more data objects; selecting a bounded region; performing an algorithm operated by a computer to produce the distribution of the one or more data objects in relation to the bounded region, the distribution positioning each data object as far as possible from any other data objects and incorporating one or more data object distribution parameters.

In another aspect the present invention is a data objects distribution system, comprising: one or more data objects; a bounded region; a computer operable to perform a data objects distribution computer program; and the data objects distribution computer program operable to produce the distribution of the one or more data objects by distributing the one or more data objects within the bounded region in accordance with the one or more data object distribution parameters to achieve a distribution of data objects whereby each data object is positioned as far from any other data objects as possible.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a flow chart showing the method of a digital image collage creation system.

FIG. 2 is a graphical abstraction of the digital image collage layout procedure.

FIG. 3A illustrates a rectangular digital image collage.

FIG. 3B illustrates a heart shaped digital image collage.

FIG. 3C illustrates a text shaped digital image collage.

FIG. 3D illustrates a cat shaped digital image collage.

FIG. 3E illustrates a digital image collage in the shape of another image.

FIG. 4 illustrates the effect of altering the number and spacing of images in a digital image collage.

FIG. 5A is a client-server model of a digital image collage system.

FIG. 5B is a client-server model of a digital image collage system

In the drawings, one embodiment of the invention is illustrated by way of example. It is to be expressly understood that the description and drawings are only for the purpose of illustration and as an aid to understanding, and are not intended as a definition of the limits of the invention.

### DETAILED DESCRIPTION

The present invention provides a method, computer system and computer program for enabling automated distribution of a plurality of data objects within a specific area. The data objects may define a specific form of object having a set boundary, for example, such as a digital image. The specific area wherein data object may be distributed is a bounded region that may be of any shape and may be, for example, a digital canvas, or section of a graphic user interface (GUI). A plurality of data objects may be positioned and arranged in relation to the bounded region, and mostly within the bounded region. A data object may be of various types and may be distributed for a variety of purposes.

It should be understood that data objects, for example, such as digital images, may have different sizes or shapes. When distributing digital images, or other data objects, within a bounded region there may be a requirement to distribute a plurality of data objects, as well as a requirement that regions of interest within each or some data objects be visible, or that the data objects be distributed in a relational distance from each other. Aesthetic considerations may also be relevant to distribution of data objects, such as a desire to arrange digital images in a specific shape.

In accordance with the present invention, the automated data objects distribution technique within a bounded region enables the distribution of data objects in a relatively high density within a bounded region by positioning and arranging the data objects as far as possible from one another based upon parameters, such as the shape of the data objects, and/or visibility of regions of interest defined within the data objects. The automated distribution technique has been designed such that it is flexible enough to permit adjustment for parameters that may also include aesthetic considerations referenced above. Maximum coverage of the bounded region may be achieved by the present invention while coverage of the data objects by other data objects is minimized.

Instead of posing the problem as a packing problem, as is applied by the prior art, the present invention arrives at an arrangement of data objects wherein each object is as far away as possible from the other objects. This calculation establishes how the data objects are distributed related the bounded region and therefore the layout of the data objects in relation to the bounded region. This formulation may be realized as a simple extension of the existing energy based formulation disclosed herein, by generalizing the region of interest function to extend beyond the borders of a data object, for example, such as the borders of a digital image. The centers of data objects may be as far as possible from one another in a distribution of the present invention, but the calculation also takes into account the shape of the data object and any regions of interest to achieve the distribution of data objects.

One embodiment of the present invention may create unique digital image collages from a plurality of images. The images included in the digital image collage and the overall digital image collage may be in a variety of different shapes. A digital canvas is defined with a boundary indicating the area within which the images are allowed to be placed. The collage creating procedure rotates and places images within the bounded region in a manner that positions and arranges the images as far away from one another as possible. Other parameters may also be incorporated into the image distribution. The present invention facilitates maximum coverage of the allowable bounded region of the canvas while minimizing the coverage of the images by other images. The collage creation may involve specified collage production system input as well as user input.

The present invention provides several benefits over the prior art. For example, prior art distributes data objects in a manner that calculates the space between objects based upon the center of the data object. This causes the center of the data object to be consistently visible. The present invention incorporates a parameter that identifies one or more regions of interest in a data object. This method ensures that the regions of interest of a data object are visible. As the region of interest may not be the center of the data object, or may not be contiguous, this is a method of consistently causing the defined area of interest in a data object to be visible, which creates a superior result.

Another benefit of the present invention is that it arranges data objects that are photos in a manner based on considerations other than the overlap of the photos. Known prior art arranges photos so as to limit overlap of photos, which restricts the collages to have a particular amount of overlap of the photos and, as such, cannot create collages where there is a significant amount of overlap of the photos or where there is no overlap of the photos at all. As described herein, the present invention distributes photos to be as far apart as possible. The present invention therefore applies a method of photo distribution that accounts for factors such as the visibility of regions of interest in a photo, even distribution of the photos, and other considerations that known prior art does not assess. Additionally, the present invention can distribute photos of different sizes through its method in a manner that considers aspects of the photos.

A skilled reader will recognize that a wide variety of data objects may be utilized by the present invention. However, to clearly exemplify the present invention the disclosure herein will reference an example of the present invention that utilizes digital images, which are data objects, to produce a collage within a collage shape, which is the bounded region.

The collage creation procedure is capable of incorporating virtually any number of images into a layout within the bounded region. Various sizing options dictate the resulting appearance of the collage, including the size of the collage, the size of the individual images within the collage, and the spacing between the images. The present invention may be operated to provide a range of collages for a given number of images and a specific collage shape. The collage shape may be a variety of shapes, for example, such as a rectangle, circle, heart, text, or the shape of a logo. The images within the collage may also be cropped in a variety of shapes. A skilled reader will recognize that other shapes may also be applied by the present invention.

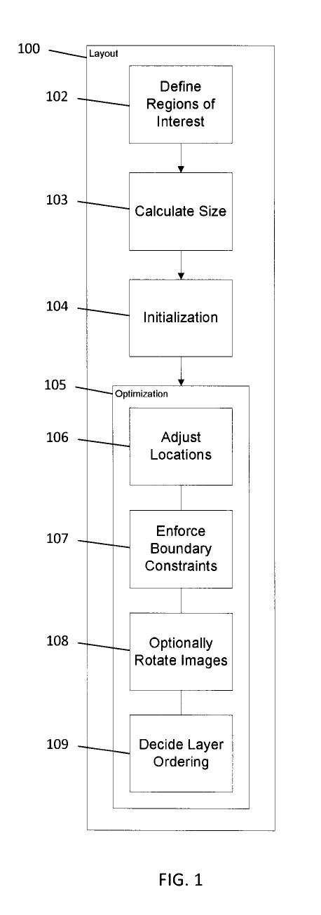

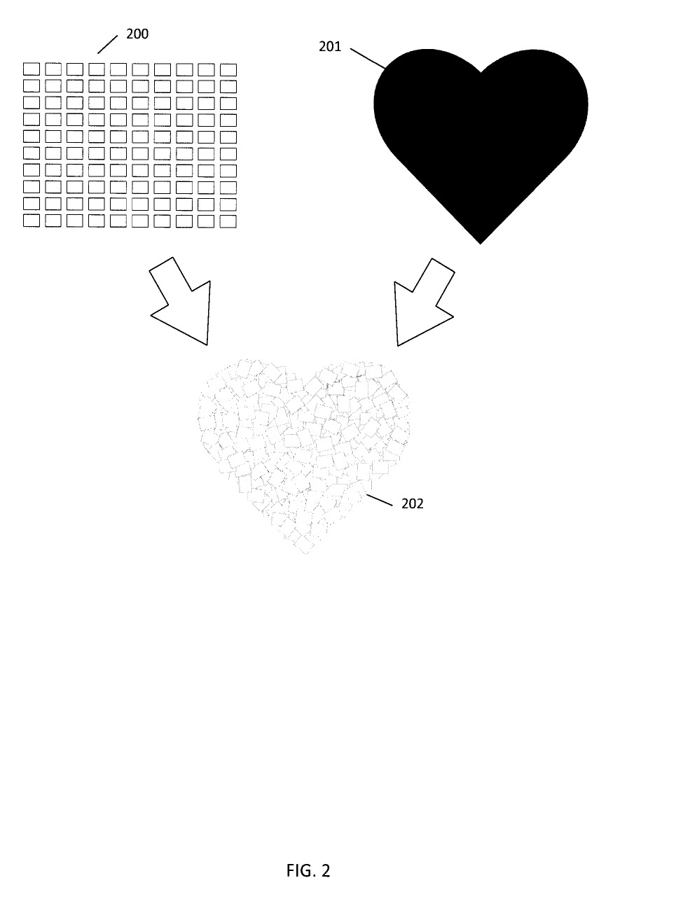

Referring now to the invention in more detail, FIG. 1 illustrates a method of collage creation, as one embodiment of the present invention. A skilled reader will recognize that the method of FIG. 1 represents a high level collage layout procedure. Other steps and details may also be incorporated into a method of the present invention. The method shown in FIG. 1 incorporates a chosen set of images as well as a chosen collage shape. As shown in FIG. 2 the collage shape may be a heart shape 201. The chosen images 200 may be arranged 202 within the collage shape.

In one embodiment of the present invention, as shown in FIG. 1, the arrangement, positioning and/or placement of chosen images within a collage shape may be performed in accordance with a layout procedure 100. The layout procedure may involve steps indicated by reference numerals 102-105. A skilled reader will recognize that other steps and/or substeps may be utilized in the layout procedure. At least one region of interest may be defined 102 in an image, that is the region or regions of the image of which is the portion desired to be visible. The images may be distributed within a collage area that represents the bounded region wherein images may be placed to create the digital collage. One or more size parameters may be calculated 103 so that any or all of the size of the bounded region, the size of the individual images within the collage, the number of images in the collage and the spacing between the images in the collage, are known. An initialization step 104 may occur whereby the data required for the methods is prepared for the optimization step.

An optimization step 105 may include the sub-steps indicated by reference numerals 106-109. The optimization method may adjust the location 106 of the digital images within the collage area. Boundary constraints may be enforced 107, to ensure the images are positioned in the collage within set boundaries. One or more images may be rotated 108, either for aesthetic reasons, to achieve a better placement of the image, or for other reasons. A decision of layer ordering 109 may be performed. The order in which optimization sub-steps occur may be dependent on the optimization algorithm that performs the optimization step. A skilled reader will recognize that other optimization steps may be added or substituted in accordance with the present invention. The optimization step may further involve cycles of sub-steps.

The method of the present invention may arrange the chosen images within the bounded region to create a digital image collage. The bounded region may be any shape and represents the finished shape of the digital image collage. The chosen images may be rotated and may overlap when arranged within the bounded region to form the digital image collage. The method of the present invention may further arrange the images within the bounded region of the collage in an aesthetically pleasing manner.

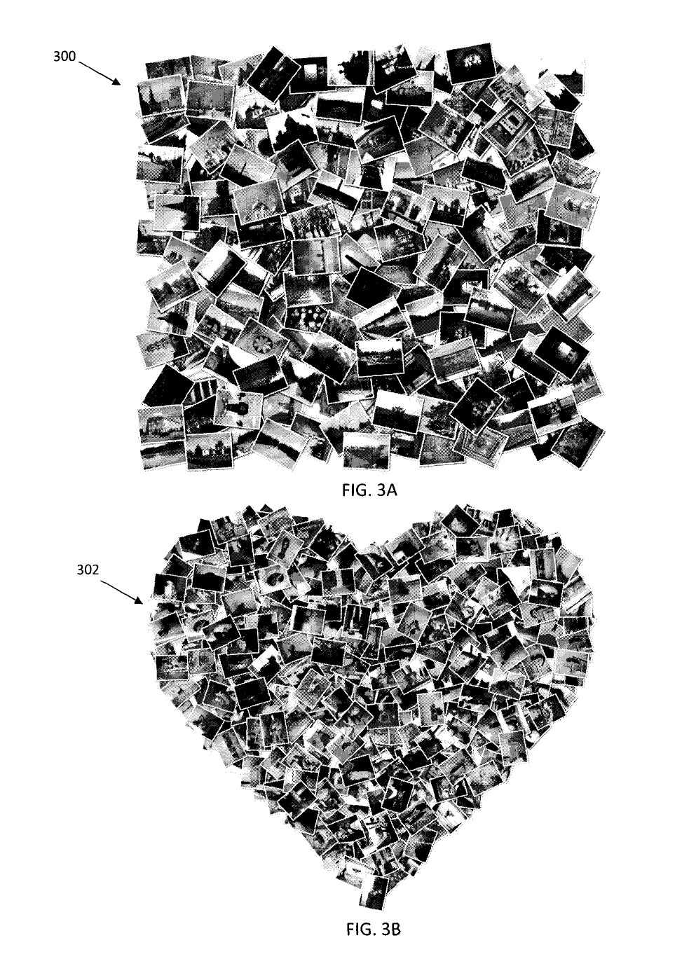

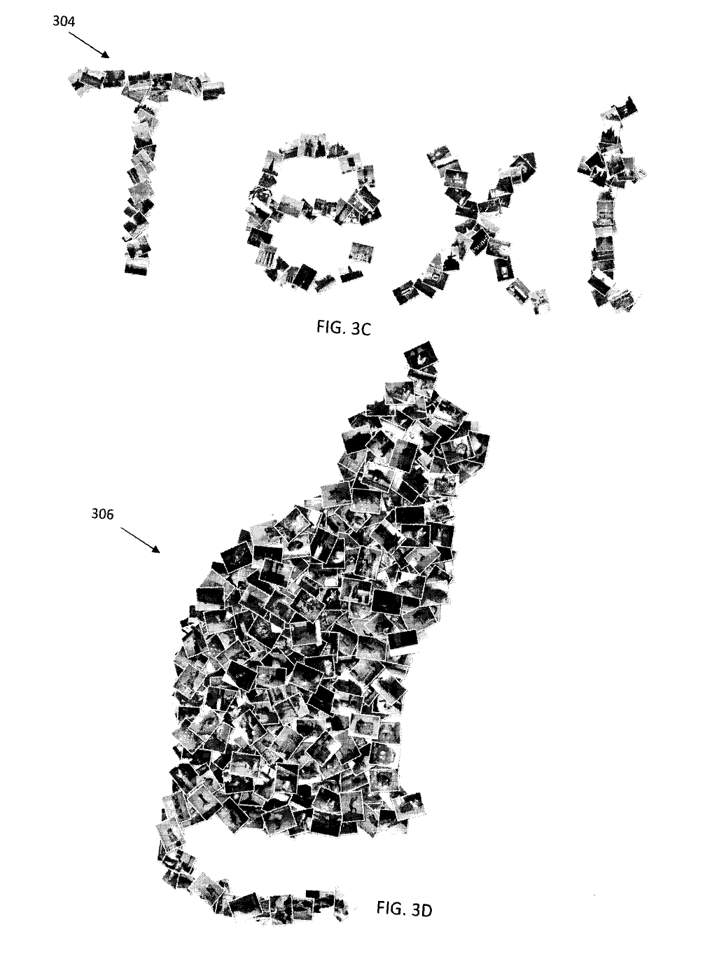

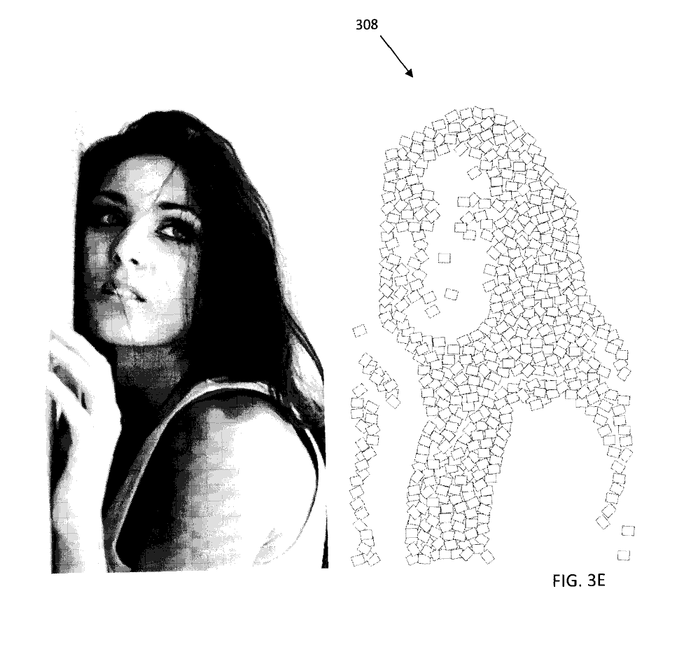

The shape of the digital image collage may take any form, and need not be contiguous. FIGS. 3A-3E provide examples of digital image collage shapes. For example, a digital image collage shape may be a rectangle 300, as shown in FIG. 3A, a heart 302, as shown in FIG. 3B, text 304, as shown in FIG. 3C, a known shape, such as an animal, for example a cat shape 306, as shown in FIG. 3D, or the shape of another image 308, as shown in FIG. 3E. A skilled reader will recognize that the shape of a digital image collage may be other shapes as well, for example, such as a circle, a triangle, a logo, or virtually any other shape. As shown in FIG. 3E, the collage shape may be the shape of another image. The other image may be binarized into a shape mask by thresholding the gray scale image. The shape of the collage may be resized to satisfy desired parameters for the digital image collage. As shown in FIGS. 3A-3E, the images positioned within the collage shape may be of various shapes and sizes.

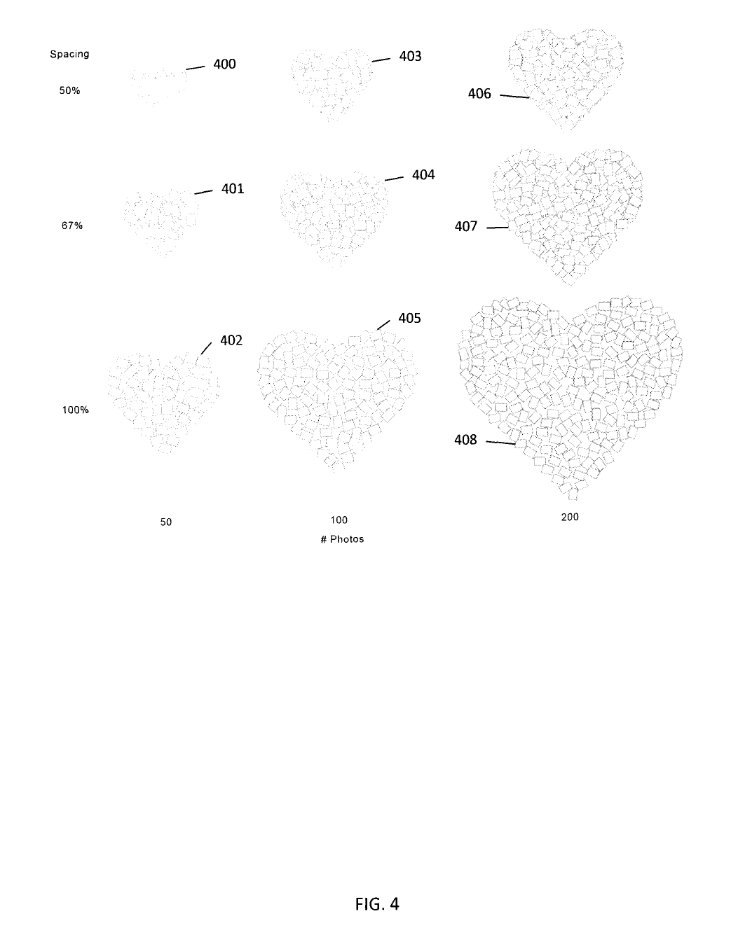

As shown in FIG. 4, the effect of a digital image collage created by the method of the present invention may be altered by changing the number of images and the spacing between the images as the images are positioned within the bounded region of the collage shape. The spacing of the images may be defined as the average distance between the centers of adjacent images as a percentage of the size of the images. For example, a digital image collage having 50 images included therein, may have a different look depending on the spacing. A collage having 50% spacing 400, is different than a collage having 67% spacing 401, and these are still different from a collage having 100% spacing 402. Moreover, a collage with 100 photos included therein at 50% spacing 403, differs from a collage with 100 photos at 67% spacing 404, and these differ again from a collage with 100 photos at 100% spacing 405. Examples of collages with 200 photos included therein having different spacings also show the variety that varying the photo content and spacing can cause, for example 50% spacing 406, 67% spacing 407 and 100% spacing 408. Furthermore, the collage shape may have a variety of overlap extremes, for example, such as a significant overlap of data objects as shown in collages 400, 403 and 406, and a minimal to virtually no overlap as shown in collages 402, 405 and 408. A skilled reader will recognize the variety of results that may be achieved by altering the spacing, sizing, number of photos, overlap, and other attributes of the digital image collage.

The arrangement and positioning of the images, as shown in FIG. 2, may be achieved automatically using the method of the present invention, which may be implemented using, for example, the computer algorithm described herein. The collage layout algorithm may require the incorporation of particular data. Such information may include: a set of digital images 200; the chosen shape of the collage 201; and parameters relating to the size of the images, size of the collage, number of images in the set of images, and the spacing between the images. The algorithm may be configured so as to position and arrange the images in an aesthetically pleasing manner 202. Although the aesthetic quality of the arrangement of images in the collage may be subjective, the algorithm may quantify aesthetic quality to a certain degree. Such a quantification of aesthetic quality may include several elements including: even covering of the area within the bounded region within the collage shape by digital images; visibility of the region of interest in images; and positioning of the images within the bounded region of the collage shape. A skilled reader will recognize that other elements may be applied in the algorithm to quantify aesthetic quality.

The collage layout algorithm, in one specific implementation thereof, begins by defining the “important” part, focal point, or “region of interest” (ROI) of each image 102, as shown in FIG. 1, in the set of digital images. The ROI of an image may be identified as a subset of the image which contains one or more portions of the image that are required to be visible in the collage. The collage layout algorithm may function so as to avoid covering up the ROI of an image with any other images. The ROI of an image may be identified in a variety of methods. For example, the ROI may be specified manually by a user; or it may be calculated automatically by the collage layout algorithm. The ROI of an image may be any portion of an image. For example, it may be an object that is the intended subject of a photograph, or it may be a background object in an image.

In one embodiment of the present invention, to identify an ROI that is one or more persons in an image, a face detector may be used to isolate one or more persons in the image and to specify the isolated one or more persons as the ROI of the image. It is also possible for an embodiment of the present invention to utilize domain specific object detection to identify ROIs. In yet another embodiment of the present invention, a set, or collection, of digital images having one or more ROIs that consist of objects that are distinct from their surroundings, a saliency detector, for example, such as that disclosed in Itti, Koch, Niebur, “A Model of Saliency-Based Visual Attention for Rapid Scene Analysis”, in IEEE Trans. Pattern Analysis and Machine Intelligence (PAMI), Vol: 20, Issue: 11, pp. 1254-1259, 1998, can be used to determine the ROI. It is possible that an image may not have a single, identifiable ROI. For example, images such as landscape and background images, may not have a single, identifiable ROI. The present invention may identify the center of an image that lacks a single, identifiable ROI as the ROI.

The outer limits of the ROI of an image can be bounded in a variety of forms. Such forms may be a particular shape. For example, the boundary of an ROI may be a rectangle, an ellipse, or a non-contiguous mask. A skilled reader will recognize that several other boundaries may be set for an ROI of an image.

An ROI may be represented mathematically in an embodiment of the present invention. For example, the mathematical representation of the ROI function for a given image may account for the varying degree of interest and yield a real number. It is also possible for the mathematical representation of the ROI function to be a binary value. A skilled reader will recognize that other mathematical representations of a ROI function are possible for the present invention and are adaptable for use in combination with the image distribution technique described herein.

Embodiments of the present invention may incorporate one or more means of manipulating an image. For example, an image may be cropped based on its ROI. An image may also be resized so as to be a particular size prior to being arranged or positioned in the collage. An embodiment of the present invention may recognize a relationship between aspects of the collage, for example, such as: the size of a collage, W×H; the average size of the images, w×h; the number of images, N; and the spacing between images, s, where s is the average distance between the centers of two adjacent images as a percentage of the size of the image, i.e. for s=0.75, for two unrotated images, there would be an overlap of 25% between the images and for s=1, for unrotated images, there would be no overlap. Such aspects of a collage may be utilized to facilitate calculations relevant to the arrangement or positioning of images in a collage. For example, assuming the present invention is applied to create a digital image collage having a rectangular shape and incorporating equal sized digital images, then WH≈wh*N/s, simply by the area of coverage of the images. As another example, for a digital image collage created having a non-rectangular shape, WH may be replaced by the area of the shape region, or shape mask, where an image can reside.

In an embodiment of the present invention it may be possible for a fourth aspect to be calculated if three aspects are provided, assuming a fixed aspect ratio 103. For example if W×H, w×h and N are known then s may be calculated. The operation of the present invention to calculate a fourth aspect when three aspects are provided may allow for a multitude of different collages to be created. For example, a variety of different collages may be produced using the same collage shape and set of images. By altering the size of the images and/or the spacing between images a variety of different collages may be created. A skilled reader will recognize that altering other aspects of the collage may further produce a variety of collage creations.

There is virtually any number of images that may be utilized within a collage. Additionally, the set of images can be duplicated or sub-sampled as necessary in order to obtain the desired number of images in the collage.

In one embodiment of the present invention, once the ROI of each of the images to be arranged and positioned in a collage is known, an algorithm may be applied to ensure that the images are placed in the collage so as to maximize the visible portion of the ROI of each image 105. The algorithm may apply the following equation for this purpose:

$${E}_{i} = {\sum }_{j / i} {f}_{{1}_{j}} ( {I}_{i} ) ,$$

where Eᵢ is the energy for the i^{th} image, Iᵢ, and f_{I}_{ⱼ} (•) is the ROI function. Eᵢ quantifies how much the i^{th} image overlaps the ROI of other images. Overlap may be minimized. Taking into consideration all the images in the collage, the total energy may be:

E=ΣᵢEᵢ.

Simply minimizing the amount of overlap of images in the collage may be insufficient to produce an aesthetically pleasing collage. As shown in FIG. 4, the effect of increasing the spacing between the images in the collage can have an effect upon the collage created. In some applications of the present invention, the spacing between images can be increased so that the images do not overlap at all. It is also possible to decrease spacing between images. An embodiment of the present invention may include a calculation to quantify an aesthetically pleasing collage as generally requiring that the images be evenly disbursed throughout the bounded region of the collage shape.

In one embodiment of the present invention the problem of evenly placing the images in the collage may be related to the rectangular packing problem, which is known to be NP complete. In such an embodiment, an approximation may be used for computational efficiency. Instead of posing the problem as a packing problem, the problem in accordance with the present invention is addressed to arrive at a method of arranging the images so that each image is as far away from the other images as possible. This calculation may dictate how the images are spread out in the collage layout within the bounded region of the collage shape. This formulation may be realized as a simple extension of the existing energy based formulation provided above by generalizing the ROI function to extend beyond the borders of the image.

The generalized ROI function can take several forms. The present invention may apply an ROI function that decreases in value the further the ROI is from the actual image. One example of the generalized interest function is the normal distribution function:

$$( x ; {μ}_{j} , {Σ}_{j} ) = \frac{1}{2 π {\vert {Σ}_{j} \vert}^{1 / 2}} exp ( - \frac{1}{2} {d}^{T} {Σ}_{j}^{- 1} d ) ,$$

where μⱼ is the center of the ROI of the j^{th} image, Σⱼ is the covariance matrix such that the covariance ellipse contains the ROI, and d=x−μⱼ. As a simplification of the previous energy equation, only the center of the i^{th} image may be considered to avoid having to integrate over the support of the image:

$${E}_{i} = {\sum }_{j / i} ( {x}_{i} ; {μ}_{j} , {Σ}_{j} ) .$$

The energy minimization may be achieved by a number of different approaches. A simple and fast gradient descent optimization procedure is presented here. To initialize 104 the energy minimization optimization procedure 105, the images are placed at random locations in the area of the bounded region of the collage shape. For example, the center, x, may be randomized by uniformly sampling locations in the bounded region. Other location initialization may also be used such as deterministically placing the images in a grid, but only in locations fully within or partially within the bounded region, where the grid has been sized so that there are sufficient valid locations for the images in the grid and the grid may be permit the images to overlap.

The images may be optionally rotated by randomizing the rotation angle, θ, for each image. The rotation angles may be sampled from any desired distribution of values. The layer ordering of the images can either take a particular sequence ordering or may be simply randomized. By fixing the parameters for all of the images except the i^{th} image, optimizing only the energy of the i^{th} image can be facilitated by gradient descent. The differential with respect to the center of the i^{th} image may be given by:

$$\frac{\partial {E}_{i}}{\partial {x}_{i}} = {\sum }_{j / i} ( {x}_{i} ; {μ}_{j} , {Σ}_{j} ) {Σ}_{j}^{- 1} {d}_{ij} .$$

The location of the i^{th} image may then be adjusted 106 according to the update equation:

$${x}_{i} ← {x}_{i} + α \frac{\partial {E}_{i}}{\partial {x}_{i}} ,$$

where α is the learning rate. A large learning rate may allow the image to make large updates and a small learning rate may result in minor adjustments. The learning rate may be changed during the optimization process to take advantage of both extremes.

To enforce the bounded region of the collage shape 107, if after this update, any part of the image is located outside of the bounded region, then the center of the image may be moved to the closest point in the collage whereby the image is fully positioned within the bounded region.

In non-trivial collage shapes, for example, such as collage shapes that involve sharp corners and narrow sections, images may not be able to wholly fit within all areas of the bounded region of the collage shape. In an embodiment of the present invention that strictly enforces the bounded region so as to constrain the placement of images, no images will be positioned or arranged in areas of the bounded region that are unable to wholly fit images.

In another embodiment of the present invention the bounded region of the collage shape may be less strictly enforced and fewer constraints may be imposed so that images may not be required to wholly fit within areas of the bounded region of the collage shape in order to be positioned or arranged in such areas. Instead of requiring that the images remain within the bounded region of the collage shape, even areas of the bounded region that do not wholly fit images may still have images positioned or arranged to cover the area. In such an embodiment all of the bounded region of a collage shape may be fully covered by images. One method to implement relaxed constraints upon the arrangement and/or positioning of images may be to move the center of an image that has any portion located outside of the shape of the collage to the closest point in the bounded region of the collage shape and then to continuously move the image further into the bounded region until the area of the collage shape covered by the image stops increasing.

In an embodiment of the present invention that applies the algorithm referenced above, once an image reaches the boundary of the collage shape, it cannot ever leave the edge since images in the interior of the shape push the image against the edge and there are no images on the other side of the edge to push the image back into the interior of the shape. To correct for this, before computing the gradient for a particular image, the location of the image may be “perturbed” slightly by adding a small amount of random Gaussian noise:

xₓ←xₓ+γₓ

x_{y}←x_{y}+γ_{y}

γₓ,γ_{y}˜ [symbol] (0,φ).

This slight perturbation may aid in resolving edge local minima issues. If this perturbation moves an image along an edge, away from an edge, even slightly, this may allow the image to be positioned or arranged in the interior should the perturbation position the image such that the images along the edge overcome the force of the other images that wish to push the image back to the boundary edge.

In one embodiment of the present invention, the rotation of the images 108 can be optionally optimized in a similar fashion to the location of the images:

$${θ}_{i} ← {θ}_{i} + α \frac{\partial {E}_{i}}{\partial {θ}_{i}} .$$

In another embodiment of the present invention, the images along the boundary of the shape may be optionally rotated to be aligned with the boundary edge. This rotation optimization step may create a sharper boundary edge effect.

In yet another embodiment of the present invention, there may be specific restrictions placed upon the range or distribution of angles of the images. These restrictions can be enforced after the computation of this update equation. This step is not essential, as without it, the location updates will simply pack the images into the collage as best as possible given the initialized rotation angles. Also, the images need not be rotated at all. Should the images not be rotated, there may be nothing to optimize in terms of the rotation of the images.

These update procedures for the location and rotation angle may be performed for each image in a collage. The procedures may be performed in a random order. The entire process may be iterated until the total energy converges. In collages that incorporate a large number of images, the energy function and gradients can be approximated in a computationally efficient manner by only summing over the nearby images, rather than all the images within the collage. This may be computationally efficient because the affect of images may decrease with distance.

The description of the collage layout algorithm above ignores the layers of the images during the layout procedure for reasons of computational efficiency. The ordering of the images can be manually specified, randomized, ordered by various criteria such as date/time, face content, etc., or optimized in a separate procedure. To perform this optimization, the energy equation above may be applied, but instead of utilizing the whole image an integration over the intersection of the areas of a pair of images may be performed:

$${E}_{ij} = {\int }_{{I}_{i} ⋂ {I}_{j}} {f}_{{I}_{j}} ( x ) d x .$$

This energy term may quantify the amount of the ROI that the i^{th} image overlaps of the j^{th} image. The total energy may be the sum over all pairs of images and may need to be minimized. A number of algorithms can be used to perform the minimization. One simple and fast method may be to take a greedy approach where the image overlapped by the other images the most, ΣᵢEᵢⱼ, is the image on top, and the rest of the ordering follows in the same manner, but ignoring the images already placed in the ordering sequence.

Given the layout of the images within a collage, the rendering of the collage may involve performing the necessary resizing and rotating and rendering of each image to be incorporated in the collage within the canvas of the collage at the location and in the order specified by the layout. Several options can be applied during the rendering, for example, such as rendering a border around each image, adding drop shadows, incorporating a background image, adding various decorations, for example, such as text, patterns, logos, icons, tinting the images, and/or blending the images together to form a seamless collage. The collage output may be produced in any number of formats, for example, such as a rendered bitmap image, a file format that retains the separate layers of the collage, and/or a format that includes the identity of each image and optionally contains pointers to the original location of the images for each location in the collage.

Numerous variations to the creation of a collage produced utilizing the same model can be achieved through simple modifications. Embodiments of the present invention may include one or more of the aspects required to achieve specific collage variations. For example, the edges of the shape of the collage can be made “jagged” so that the images have more of a natural or messy appearance and are not exactly lined up with the edges of the collage. This effect can be achieved by either modifying the shape edge accordingly or by randomly perturbing the location of the images along the edges of the collage shape. The system of the present invention may function so as to place particular images in certain areas of the collage or to enforce a spatial ordering of the images, to produce a specified product. This effect can be achieved by adding terms to the energy function whereby particular images may be directed to prefer certain locations, or by adding pair-wise (or n-wise) functions between images to the energy function. The images may also be initialized in such a way that specified spatial characteristics may be satisfied and the learning rate set to a low value. The result may be that images do not stray far from their initial positions. A mosaic-like effect may be achieved by placing images in certain areas of the collage that match the color or texture of a reference image overlaid on the collage shape. This effect can be achieved by adding a term to the energy function for the color similarity between the image in question and the underlying desired color for a particular location in the collage. A skilled reader may recognize that other variations may also be possible and incorporated into the present invention.

While the collage construct has been presented here as being of a fixed size, the collage may be of a virtually infinite choice of sizes. Any size chosen will define the bounded region of the collage shape. For example, in a small sized collage, only a small bounded region may be presented. Additionally, as the collage is created a window that is a portion of the total bounded region may be shown to a user. The collage method of positioning and arranging images may begin from the window area. A collage of a size at least as large as the window may be created, and as the window view is shifted to areas beyond the computed area of the collage, the collage canvas may be extended and additional images added to the collage layout for this extended area using the method described in this present invention. This extension may be performed a virtually infinite number of times and the images may be duplicated as necessary to fill the collage canvas. When performing the layout in this extended region, the previously laid out images in the collage may be taken into consideration to create a seamless transition into this extended area. These previously laid out images may be fixed to maintain a static collage effect. The shape of the collage in this construct may be a rectangle, which would simply mean that the images may be placed anywhere in the collage. The shape could also be one that tiles to an infinite size or be represented as a function with a support that spans the entire domain of real numbers.

The collage layout method described for this present invention assumes that an aesthetically pleasing collage may require an even distribution of the images throughout the collage. Even distribution is not required for all embodiments of the present invention, or for all collages. It is possible to create collages having different densities of images within the collage, in accordance with the present invention. This density effect, similar to stippling, can be achieved by making the generalized region of interest function dependent on the location within the collage, g_{I}_{ⱼ}(Iᵢ)=f_{I}_{ⱼ}(Iᵢ)h(xⱼ), where xⱼ is the center of the j^{th} image. The h(•) function is the density function and is lower for areas where it is desired to have higher density of images, since the optimization procedure is constructed as an energy minimization.

Those skilled in the art will realize that the software to generate collages of the present invention may be operated on a number of different platforms and devices, as well as in a variety of configurations. For example, a local computer may run the software in its entirety, involving computing the layout of the collage given the images, shape, and optionally, any user option input, rendering the images within the collage, and displaying the collage to the user. The local computer may also use the produced collage as it formats, such as a bitmap image. The local computer may also use the produced collage as it would with any other image, for example, for printing and sharing purposes. As another example, the software may also be implemented in a client-server model, whereby a local or terminal computer provides the images or specifies where to locate the images, the shape of the collage, and optionally any user options to a remote computer. The remote computer, such as a web server on the Internet, can perform part or all of the collage creation.

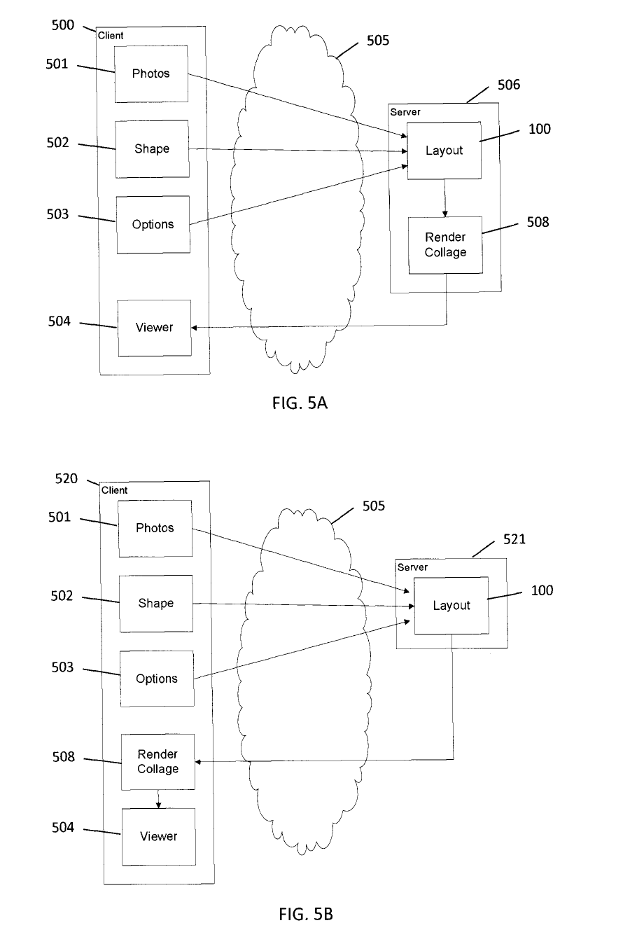

In one embodiment, as shown in FIG. 5A, a remote computer 506 may receive the digital images 501, shape 502, and other options 503 from a local computer 500 through a communication mechanism 505, such as the Internet. The remote computer may perform the layout 100 and rendering 508 of the collage and return the collage produced for the local computer 500 to display to the user by way of a viewing means 504, such as a screen or other viewing means. The local computer 500 may also store the collage in a variety of file formats, for example, such as a bitmap image. The collage may be displayed by accessing and utilizing the stored collage at a later time. The remote or local computer may also use the produced collage as it would with any other image or data object, for example, such as for printing and sharing purposes.

As shown in FIG. 5B, the remote computer 521 may receive the digital images 501, shape 502, and other options 503 from a local computer 520 through a communication mechanism 505, such as the Internet. In this embodiment the local computer 520 may only perform the layout 100. The local computer 520 may render the collage 508 and transfer the rendered collage to a viewing means 504, such as a screen or other viewing means. The local computer 520 may undertake several applications relating to the collage, for example, such as storing the collage to a file, printing the collage, sending the collage to another computer, or utilizing the collage or images therein in any other way that other images and/or data objects are used. The collage may be viewed by a user by use of the viewing means. Those skilled in the art will recognize that a variety of software and hardware configurations are possible for the present invention. A skilled reader will additionally recognize that electronic devices utilized in the present invention may a variety of devices, for example, such as mobile phones, media players, video game devices, and home entertainment systems.

A skilled reader will recognize that the media other than digital images may be utilized in the present invention. The above description that identifies the method of the present invention as applying digital images to render a collage is only an example. The present invention may be applied to a range of different objects and output results for various applications. For example, in maintaining the identity of the image for each location in a collage, the output can be used for an image browsing application. The location of the images within the collage may be perturbed by the user to aid the user in locating different images and the resulting movement of the images can be guided by a combination of a physics model, for example, such as a spring model, utilizing the above disclosed layout procedure.

Additionally, the collage need not be displayed in a static manner and various displays of the collage can be achieved whereby the images dynamically move, float, or fly around with the movements guided by the layout procedure combined with random perturbations and optionally a physics model to provide for smoother motion. The images in this animated collage may also morph between different shape configurations.

The collages may not be restricted to being viewed in 2D. Since the ordering of the layering of the images is known, a 3D visualization or format may be created and displayed using 3D display technology. In such a display, the individual images may have different depths, according to the layering utilized, and those that appear as being layered on top of other images may appear to be, and be perceived by a user as being, closer to a viewer than those being layered below.

In one embodiment of the present invention, the data objects may not need to be restricted to 2D shapes. For example, images may be arranged on a 3D surface or within a 3D volume. The images may also undergo various 3D transformations, for example, such as translations, rotations and warpings.

In another embodiment of the present invention, a video collage may be created in the exact same manner described in this invention by replacing images with videos. A dynamic video collage where the video objects move through time may have its motion guided by generalized region of interest functions that change for each frame of the video sequences. The method presented here is not restricted to strictly 2D objects and the method generalizes in a straight forward manner to 3D or ND objects and layouts.

It will be appreciated to those of skill in the art that the present design may be applied to other systems that perform efficient placement functions, such as floor planning for certain types of objects or items. In particular, it will be appreciated that various types of optimal or enhanced placement functions may be addressed by the functionality and associated aspects described herein.

A skilled reader will further recognize that the steps of the methods of the present invention disclosed herein may be carried out in a variety of orders. This includes any suitable order to achieve a specific output. It further includes that the steps be carried out simultaneously, where appropriate.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed. It will be appreciated by those skilled in the art that other variations of the embodiments described herein may also be practiced without departing from the scope of the invention. Other modifications are therefore possible.

We claim:

1. A method of creating a distribution of one or more data objects in relation to a bounded region, characterized in that it comprises:
a) selecting the one or more data objects;
b) selecting the bounded region;
c) performing a computer implemented operation to create the distribution of the one or more data objects in relation to the bounded region, said distribution operating to position each of the one or more data objects as far as possible from any other of the one or more data objects, and said distribution further incorporating one or more data object distribution parameters.

2. The method of claim 1, characterized in that it comprises the further steps of: identifying a region of interest in one or more of the one or more data objects; and creating the distribution of the one or more data objects in relation to the bounded region so as to position the one or more data objects and to cause the identified region of interest in the one or more data objects to be visible.

3. The method of claim 2, characterized in that it comprises the further step of cropping at least one of the one or more data objects in relation to the identified region of interest of said at least one of the one or more data objects.

4. The method of claim 1, characterized in that it comprises the further step of applying one or more of the following data object distribution parameters:
a) shaping of the one or more data objects;
b) sizing of the one or more data objects;
c) even distribution of the one or more data objects; and
d) one or more parameters to achieve a specific aesthetic result.

5. The method of claim 1, characterized in that it comprises the further step of rotating at least one of the one or more data objects to achieve the distribution of the one or more data objects in relation to the bounded region.

6. The method of claim 1, characterized in that it comprises the further steps of the distribution positioning the one or more data objects to achieve maximum coverage of the bounded region; and the distribution positioning the one or more data objects to achieve minimum coverage of each of the one or more data objects by other of the one or more data objects.

7. The method of claim 1, characterized in that it comprises the further step of distributing the one or more data objects upon a bounded region that is one of the following shapes: a rectangle, a circle, a heart, text, a logo, or an image-shape.

8. The method of claim 1, characterized in that it comprises the further steps of: characterizing the relationship between at least two of the following:
a) size of the bounded region;
b) average size of the one or more data objects;
c) total number of the one or more data objects; and
d) spacing between the one or more data objects;
as collage aspects; and the distribution utilizing the collage aspects to facilitate calculations to arrange and position the one or more data objects.

9. A data objects distribution system, characterized in that it comprises:
a) a client computer operable to:
i) define one or more data objects;
ii) define a bounded region; and
iii) define one or more data object distribution parameters;
b) a display means linked to the client computer, said display means being operable to display information to a user; and
c) a remote computer linked to the client computer, said remote computer being operable to:
i) receive the one or more data objects, bounded region and one or more data object distribution parameters;
ii) perform a data objects distribution computer program to create the distribution of the one or more data objects by distributing the one or more data objects within the bounded region in accordance with the one or more data object distribution parameters to achieve a distribution of the one or more data objects whereby each of the one or more data object is positioned as far from any other of the one or more data objects as possible.

10. The system of claim 9, characterized in that it further comprises the remote computer being operable to transfer the results of the distribution computer program to the client computer, whereby the results of the distribution computer program may be displayed to a user by the display means.

11. The system of claim 9, characterized in that it further comprises: the data objects distribution computer program being operable to identify a region of interest in one or more of the one or more data objects; and the distribution utilizing the region of interest to distribute the one or more data objects in relation to the bounded region to position the one or more data objects so as to cause the identified region of interest in the one or more data objects to be visible.

12. The system of claim 9, characterized in that it further comprises at least one of the one or more data objects being one or more digital images.

13. The system of claim 9, characterized in that it further comprises the bounded region being a digital canvas or a section of a graphic user interface.

14. The system of claim 9, characterized in that it further comprises the one or more data object distribution parameters being at least one of the following:
a) shaping of the one or more data objects;
b) sizing of the one or more data objects;
c) even distribution of the one or more data objects; and
d) one or more parameters to achieve a specific aesthetic result.

15. The system of claim 9, characterized in that it further comprises the data objects distribution computer program being operable to perform at least one of the following to achieve the distribution of the one or more data objects in relation to the bounded region: rotating at least one of the one or more data objects; and cropping at least one of the one or more data objects in relation to an identified region of interest.

16. The system of claim 9, characterized in that it further comprises the data objects distribution computer program being operable to perform: positioning the one or more data objects to achieve maximum coverage of the bounded region; and positioning the one or more data objects to achieve minimum coverage of each of the one or more data objects by other of the one or more data objects.

17. The system of claim 9, characterized in that it further comprises the bounded region being one of the following shapes: a rectangle, a circle, a heart, text, a logo, or an image-shape.

18. The system of claim 9, characterized in that it further comprises the data objects distribution computer program being operable to characterize the relationship between at least two of the following as one or more collage aspects:
a) size of the bounded region;
b) average size of the one or more data objects;
c) total number of the one or more data objects; and
d) spacing between the one or more data objects; and
the data objects distribution computer program being operable to utilize the one or more collage aspects to facilitate calculations to arrange and position the one or more data objects in relation to the bounded region.

19. A data objects distribution system, characterized in that it comprises:
a) a client computer operable to:
i) define one or more data objects;
ii) define a bounded region; and
iii) define one or more data object distribution parameters;
iv) perform a data objects rendering computer program;
b) a display means linked to the client computer, said display means being operable to display a result of the data objects rendering computer program; and
c) a remote computer linked to the client computer, said remote computer being operable to:
i) receive the one or more data objects, bounded region and one or more data object distribution parameters; and
ii) perform a data objects layout computer program and transfer a result of the data objects layout distribution computer program to the client computer;
whereby the result of the data objects rendering computer program is distribution of the one or more data objects within the bounded region in accordance with the one or more data object distribution parameters to achieve a distribution of the one or more data objects whereby each of the one or more data object is positioned as far from any other of the one or more data objects as possible.
